(19) United States
(12) Patent Application Publication
(10) Pub. No.: US 2020/0410452 A1
(43) Pub. Date: Dec. 31, 2020

(54) SYSTEM AND METHOD FOR AUTOMATED EMPLOYEES RECRUITMENT

(71) Applicant: Elia Halevy, Tel-Aviv (IL)

(72) Inventor: Elia HALEVY, Tel-Aviv (IL)

(21) Appl. No.: 16/908,737

(22) Filed: Jun. 23, 2020

Related U.S. Application Data
(60) Provisional application No. 62/866,675, filed on Jun. 26, 2019.

(51) Int. Cl. G06Q 10/10; G06Q 10/06

(52) U.S. Cl. CPC G06Q 10/1053; G06Q 10/06398

(57) ABSTRACT

System and method for automated employees' recruitment including: obtaining from a recruiter a request for recruiting an employee for an open position, wherein the request comprises quantitative measures of a plurality of required skills; obtaining an application from a candidate, the application comprising quantitative measures of a plurality of skills of the candidate; analyzing the application to determine a level of suitability of the candidate for the open position based on the quantitative measures of a plurality of required skills and the quantitative measures of a plurality of skills of the candidate; and presenting the level of suitability to the recruiter.

### CROSS-REFERENCE TO RELATED APPLICATIONS

This application claims the benefit of U.S. Provisional Patent Application No. 62/866,675, filed Jun. 26, 2019, which is hereby incorporated by reference.

### FIELD OF THE INVENTION

The invention relates to automated employee recruitment. In particular, the invention relates to quantitively estimating candidates' suitability for job openings.

### BACKGROUND OF THE INVENTION

Currently, a recruiting process includes publishing an open position and obtaining job applications from candidates. The job applications typically include a one-page curriculum vitae that is prepared by each candidate. Recruiters evaluate job applications by reading the curriculum vitae. Subsequently, candidates are evaluated subjectively, based on the recruiter general impression of their curriculum vita. Thus, determining if a candidate is suitable for a job opening and ranking a plurality of candidates for a job opening may be very subjective. As a result, many times, suitable candidates may be overlooked, while less suitable candidates may be invited for interviews.

### SUMMARY OF THE INVENTION

According to some embodiments of the invention, there is provided a system and method for automated employees recruitment. Some embodiments of the invention may include: obtaining from a recruiter a request for recruiting an employee for an open position, where the request may include quantitative measures of a plurality of required skills; obtaining an application from a candidate, the application may include quantitative measures of a plurality of skills of the candidate; analyzing the application to determine a level of suitability of the candidate for the open position based on the quantitative measures of a plurality of required skills and the quantitative measures of a plurality of skills of the candidate; and presenting the level of suitability to the recruiter.

According to some embodiments of the invention, analyzing the application to determine a level of suitability of the candidate for the open position may include: calculating relative grades for at least one of the plurality of required skills, where a relative grade of a required skill may be calculated based on a relation between the quantitative measure of the required skill and the quantitative measure of the skill of the candidate; calculating a total skills grade based on the relative grades of the required skills; generating a knowledge test related to at least one of the required skills; presenting the knowledge test to the candidate and obtaining knowledge test results; calculating a knowledge test grade based on the knowledge test results; and calculating a final grade for the candidate based on the total skills grade and the knowledge test grade, the final grade suggesting the level of suitability of the candidate for the new position.

According to some embodiments of the invention, the quantitative measure of the required skill may be the number of required years of experience in the required skill, and the quantitative measure of the skill of the candidate may be the years of experience the candidate has in the required skill.

According to some embodiments of the invention, the quantitative measure of the skill of the candidate may be adjusted according to the timeline of the years of experience the candidate has in the required skill.

Some embodiments of the invention may include obtaining a plurality of applications from a plurality of candidates and analyzing each of the plurality of applications to obtain a final grade for each of the candidates; sorting the candidates based on the final grades; and presenting the sorted list to a recruiter.

Some embodiments of the invention may include automatically sending a notification to the top ranked candidates to schedule an interview with the top ranked candidates.

Some embodiments of the invention may include obtaining from a recruiter a notification that the open position is no longer relevant; and automatically notifying the plurality of candidates that the open position is no longer relevant.

Some embodiments of the invention may include obtaining contact details of at least one recommender; and automatically sending a request for a recommendation to the at least one recommender using the contact details.

Some embodiments of the invention may include obtaining a plurality of requests for recruiting employees for a plurality of open positions; upon obtaining the application from the candidate for the open position, analyzing the application to determine a level of suitability of the candidate at least one other open position of the plurality of open positions; and notifying the recruiter if the level of suitability of the candidate with relation to any of the at least one other open position is above a threshold.

Some embodiments of the invention may include presenting the quantitative measures of a plurality of skills of the candidate to the recruiter in a modified radar chart in which an area bounded by two adjacent radii represents a skill of the candidate and the quantitative measure of the skill is represented as a colored region within the bounded area.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a flowchart of a method for automated employee recruitment, according to some embodiments of the invention;

FIG. 2 is a flowchart of a method for analyzing an application to determine a level of suitability of a candidate for an open position, according to some embodiments of the invention;

FIG. 3A depicts a modified radar chart for an open position, according to some embodiments of the invention;

FIG. 3B depicts a modified radar chart of a candidate, according to some embodiments of the invention;

FIG. 3C depicts a modified radar chart for a candidate including a popup window, according to some embodiments of the invention;

FIG. 4A depicts a second modified radar chart for an open position, according to some embodiments of the invention;

FIG. 4B depicts a second modified radar chart of a candidate, according to some embodiments of the invention;

FIG. 5A depicts an example for timeline of years of experience a first candidate has in a skill, according to some embodiments of the invention;

FIG. 5B depicts an example for timeline of years of experience a second candidate has in a skill, according to some embodiments of the invention;

FIG. 5C depicts an example for timeline of years of experience a third candidate has in a skill, according to some embodiments of the invention;

FIG. 6A depicts a first partial modified radar graphs, with marking of required years of experience, according to some embodiments of the invention;

FIG. 6B depicts a second partial modified radar graphs, with marking of required years of experience, according to some embodiments of the invention;

FIG. 6C depicts a third partial modified radar graphs, with marking of required years of experience, according to some embodiments of the invention;

FIG. 7A depicts a modified radar graph including a number of years of experience together with results of the knowledge test, according to some embodiments of the invention;

FIG. 7B depicts a second modified radar graph including a number of years of experience together with the results of the knowledge test, according to some embodiments of the invention;

FIG. 8A depicts a modified radar graph including timeline of years of experience with a marking of the oldest allowed year of experience, according to some embodiments of the invention;

FIG. 8B depicts a second modified radar graph including timeline of years of experience with a marking of the oldest allowed year of experience, according to some embodiments of the invention;

FIG. 8C depicts a third modified radar graph including timeline of years of experience with a marking of the oldest allowed year of experience, according to some embodiments of the invention;

FIG. 9 is a flowchart of an automated method for recruiting a plurality of employees for a plurality of open positions, according to some embodiments of the invention;

FIG. 10 is a flowchart of an automated method for closing job openings, according to some embodiments of the invention;

FIG. 11 is a flowchart an automated method for requesting recommendations, according to some embodiments of the invention; and

FIG. 12 is a high-level block diagram of an exemplary computing device according to some embodiments of the present invention.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well-known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

Some embodiments of the invention pertain, inter alia, to the technology of employees' recruitment. Embodiments may provide an improvement to the process of employees' recruitment by, for example, improving the evaluation of suitability of an employee to an open job position. Some embodiments of the invention may obtain quantitative measures (e.g., years of experience) of a plurality of required skills for the open position and quantitative measures (e.g., years of experience) of a plurality of skills of the candidate. Some embodiments of the invention may quantitatively evaluate the level of suitability of the candidate to the open job position based on the quantitative measures. Additionally, if there are several open positions, the automated employees' recruitment system according to some embodiments of the invention may analyze the level of suitability of the candidate to other positions, even if the candidate did not apply for them.

Some embodiments of the invention may allow an automated process for employees' evaluation and recruitment to a variety of positions by advance analysis of candidates abilities, including technical skills, character etc., versus the specific demands of the open position as defined by the employers, e.g., the recruiters. When evaluating a candidate, some embodiments of the invention may analyze the skills of the candidate, the accumulated years of experience the candidate has in each skill and the timeline of these years of experience. The system may also generate knowledge tests for testing the knowledge level in each skill, provide the test to the candidate and include the test results in the analysis. Some embodiments of the invention may utilize matching algorithms including artificial intelligence (AI) capabilities to the recruitment process, thus providing the following improvement to the technology: shorter recruitment process, fewer recruiters involved in the recruitment process, increase in successful hiring, decrease in unsuccessful hiring and better resilience for recruiters turnover.

According to some embodiments, other parameters may be evaluated as well, including salary expectations of the candidate versus the salary offered by the organization, candidate residence distance from job location, etc.

As used herein, the term “recruiters” may refer to any of the personnel, e.g., of an organization or of a third party, that is involved in recruiting new employees for an organization, including professional workers and human resources (HR) workers. A “candidate” may refer to a person that has applied to an open position published by the company (the employer). A “skill” may refer to a field of expertise. For example, recruiters may offer a job position, and specify the job requirements as a list of required skills, and the required years of experience and/or knowledge level required in each skill. A candidate may provide a list of skills that he/she has, including the years of experience he/she has in each skill and the timeline of the years of experience he/she has in each skill.

According to some embodiments of the invention, a knowledge test may be generated and presented to the candidate in the required skills, in accordance with the required level of expertise. The knowledge level of the candidate may be evaluated based on the results of the knowledge test. A final score or grade suggesting the level of suitability of the candidate for the new position may be calculated for the candidate based on the total skills grade and the knowledge test grade. According to some embodiments, personality tests may be generated and presented to the candidate, based on required personality traits, such as reliability, creativity, etc., defined by the recruiter.

According to some embodiments of the invention, if a plurality of candidates apply for a single job position, these candidates may be evaluated as disclosed herein. The candidates may be sorted based on the final grades. A recruiter may invite the top ranked candidates for an interview. Similarly, if there are several open positions, candidates applying for one position may be automatically evaluated for other open positions as well. The recruiter may be notified early in the process, preventing unnecessary process for a less relevant positions.

Some embodiments of the invention may include presenting job requirements as well as candidate capabilities in a graphical user interface that may include modified radar graphs or charts. The modified radar graphs may indicate the years of experience in a plurality of fields of knowledge, e.g., a first radar graph may include the required years of experience in each required field of knowledge, and a second radar graph may include the years of experience a candidate has in each of these fields of knowledge as well as a timeline of the years of experience the employee has in each field. Thus, the modified radar graphs may enable visual review and comparison between the job requirements and the candidate's capabilities. The two radar graphs may be superimposed on each other.

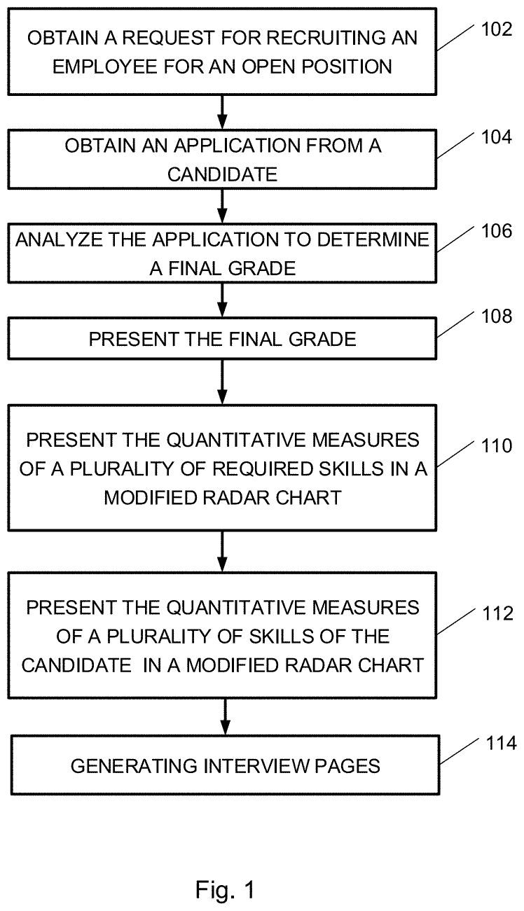

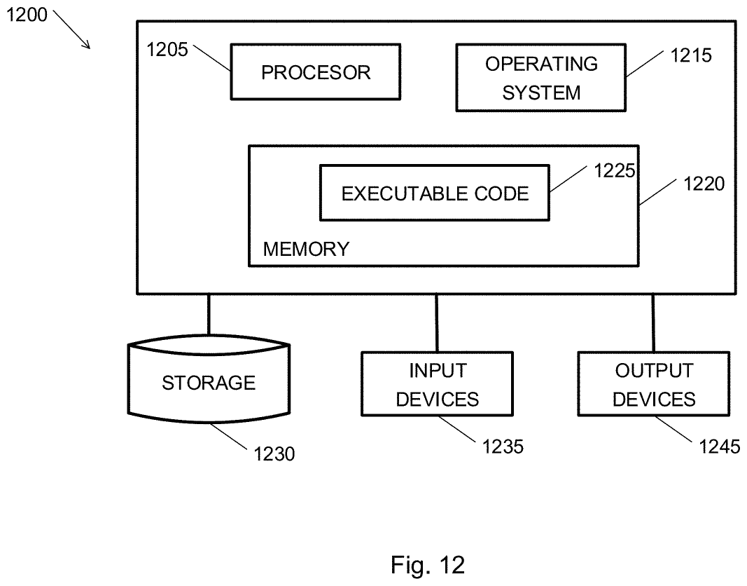

Reference is now made to FIG. 1, which is a flowchart of a method for performing automated employees' recruitment, according to some embodiments of the present invention. The method for automated employees' recruitment may be performed, for example, by processor 1205 presented in FIG. 12, or by another system.

In operation 102, a request for recruiting an employee for an open position in an organization may be obtained. The request may include a list of required skills for the job position and quantitative measures (e.g., years of experience) of the plurality of required skills in the list. In some embodiments, the request may include relative importance, or weights of the different skills. For example, the request for recruiting an employee for an open position may be obtained from a recruiter within the organization, e.g., an HR recruiter or a professional manager. When a request is opened, the other employees involved in the recruiting process may be automatically notified, e.g., by an e-mail message or any other notification. The professional manager, for example, may fill in the required skills as well as the level of expertise in the required skills. The required skills may be provided as a list of fields of expertise, e.g., structured query language (SQL), cyber security, Windows operating systems (OS), Java, etc., The level of expertise in each of the required skills may include a quantitative measure of the level of expertise. For example, the quantitative measure of a required skill may include the number of required years of experience in the required skill or field of expertise, the timeline of the years of experience and/or the required expertise level. The scale for the required expertise level may be numerical or qualitative. The quantitative measure of a required skill may include a required grade or score in a knowledge test.

The recruiter can define in the open position requirements regarding the timeline of years of experience. For example, a recruiter may indicate that, for a certain skill, the required years of experience will be within the last five years (e.g., between 2014-2019). The recruiter may also require that the years of experience be continuous. Other requirements may be defined.

According to some embodiments, the request may include a list of required personality traits. According to some embodiments, open position may be saved as templates for future usage, saving time and money when a similar position is opened again. Thus, a recruiter may be offered to use a template when issuing a request for recruiting an employee for an open position. Additionally, templates may be automatically learned by analyzing demands in other companies or in other job openings in the same organization.

According to some embodiments, a request for recruiting an employee for an open position may be opened by an HR recruiter which may enter the following information:
Position number.
Position name.
Relevant department.
Geographical location.
Appointment percentage.
Number of positions.
HR recruiter details (name, email, etc.).
Professional manager details (name, email, etc.).
Number of desired recommenders.
Relevant documentational evidence needed (degrees, approvals, etc.)
Relevant wage range.
Relevant geographical boundaries for candidates.

The new position may be sent to a professional manager which may add technical requirements, for example:
Desired skills (technical skills, fields of knowledge, e.g., specific software and hardware tools, languages, etc.
Desired years of expertise for each skill separately.
Excepted standard deviation for each skill (or generally for all skills).
Maximum years without practicing for each skill (or generally for all skills).
Top importance skills or weights for skills.
Custom professional questions he would like the candidates to answer in a knowledge test.
Relevant documentational evidence needed, e.g., degrees, approvals, etc.

Other processes for opening a new request for recruiting an employee for an open position may be followed.

In operation 104, an application (e.g., a job application) from a candidate may be obtained. The application may include quantitative measures of a plurality of skills of the candidate. For example, the quantitative measure of a skill of the candidate may include the number of years of experience that the candidate has in the skill or field of expertise and the timeline of the years of experience. According to some embodiments, when a candidate is applying for a certain position, he/she may be required by the system to submit his application, including for example personal information, previous roles, skills and recommenders, and any other information as may be required.

Candidates may be invited to apply to open positions in several methods. For example, candidates may be invited to apply by obtaining an e-mail address and sending the position application task to the obtained e-mail address. According to some embodiments, candidates may be invited to apply by following a link leading directly to the application task. The link may be published in various locations, e.g., company websites, social media, third party recruiting services, etc.

In some embodiments, once a candidate clicks the link for the task, he/she may be asked to register to a candidate portal and to fill an application. The candidate may be requested to fill in general information about himself, for example full name, identification (ID) number, address and desired wage range. The candidate may be requested to enter his/her past experience. For each position the candidate may be requested to fill in a start month and year, an end month and year, company name and position name. Additionally, the candidate may be requested to enter a list of skills, e.g., by selecting skills from a suggested list of skills, and the years of experience in each skill.

The candidate may be requested to enter recommenders' details, mentioning to which position each recommender is relevant. Finally, the candidate may upload any required document.

In operation 106, an application may be analyzed to determine a final score or level of suitability of the candidate for the open position based on the quantitative measures of a plurality of required skills and the quantitative measures of a plurality of skills of the candidate.

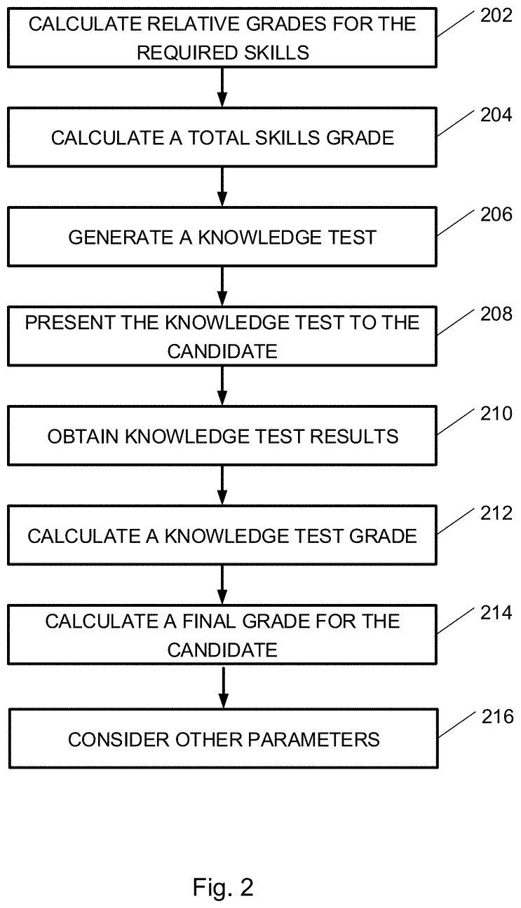

Reference is now made to FIG. 2 which is a flowchart of a method for analyzing an application to determine a level of suitability of a candidate for an open position, according to some embodiments of the invention. The method for analyzing an application to determine a level of suitability of a candidate for an open position may be an elaboration of operation 106 presented in FIG. 1, and may be performed, for example, by processor 1205 presented in FIG. 12, or other system.

In operation 202, relative grades may be calculated, estimated or determined for at least one of the plurality of required skills. According to some embodiments of the invention, a relative grade (also referred to herein as skill grade) of a required skill may be calculated based on a relation between the quantitative measure of the required skill and the quantitative measure of the skill of the candidate. For example, the relative grade of a required skill may be calculated by (other equations may be used):

$$skill\_grade = \frac{c andidate\_years}{re quired\_years}$$

Where candidate_years denotes the number of years of experience that the candidate has in the skill or field of expertise, and required_years denotes the number of required years of experience in the required skill or field of expertise.

According to some embodiments, the skill grade may be adjusted by the timeline of the years of experience the candidate has in the skill or field of expertise. For example, continuous years of experience (e.g., 2014, 2015, 2016) may get higher grade than inconsistent years of experience (e.g., 2012, 2015, 2018), and more recent years of experience (e.g., 2017-2019) may get a higher grade than less recent years of experience (e.g., 2011-2013). In operation 204, a total skills grade may be calculated based on the relative grades of the required skills. For example, a total skills grade or score may be calculated as an average of the total skills. According to some embodiments, the total skills grade may be calculated as a weighted average, giving different weights to different skills according to the job requirements, as specified by the recruiter.

In operation 206, a knowledge test or tests related to at least one of the required skills may be generated. For example, by pulling questions (e.g., randomly) from a pre-made questions bank. For example, a single skill test may be composed of multiple questions intended to validate the candidate knowledge in a tested skill. According to some embodiments, personality tests may be generated as well, based on the required personality traits defined by the recruiter. In operation 208, the knowledge test or tests, as well as the personality test if needed, may be presented to the candidate, and in operation 210. knowledge test results (and results of the personality tests if applicable) may be obtained. For example, the candidate may provide answers to questions in the test or tests. In operation 212, each tested skill may receive a test grade or score separately, e.g., in the range of 0-100, according to the answers provided by the candidate. In operation 212, a cumulative knowledge grade or score may be calculated as an average or weighted average of the test scores of the separate skill tests. In some embodiments, a single skills test may be composed for all the tested skills, and the cumulative knowledge grade or score may be the grade or score of the single test. In operation 214, a final grade or score for the candidate may be calculated as an average or weighted average of the cumulative knowledge grade and the total skills grade. The final grade may be related to or provide an estimate of the level of suitability of the candidate for the open position. According to some embodiments of the invention, results of the personality tests may be calculated as well.

In operation 216, other parameters may be considered, if relevant. For example, the wage demands of the candidate may be compared with the wage offered by the recruiter, the candidate residence distance from work may be compared with the recruiter demands, results of the personality tests, feedback form recommenders, etc. In some embodiments, the final grade or score for the candidate may be adjusted according to the other parameters. In some embodiments, a separate score or grade may be provided for the other considerations, or the other considerations may be provided to the recruiter as a list of comparisons.

According to some embodiments, some knowledge tests, depending on the customer HR recruiter or professional manager decision, may include recording of the candidate reading a certain sentences or paragraphs or speaking freely in order to evaluate candidate's oral abilities in certain languages.

Returning to FIG. 1, in operation 108, the final grade, or the level of suitability, may be presented to the recruiter. In operation 110, the quantitative measures of the plurality of required skills of the candidate may be presented in a modified radar chart. In operation 112, the quantitative measures of the plurality of skills of the candidate may be presented in a modified radar chart. In the modified radar chart, an area bounded by two adjacent radii represents a skill, e.g., a required skill or a skill of the candidate, and each year of experience may be represented as an area bounded by two concentric circles. In some embodiments, a timeline view may be provided, in which the outmost bounded area represents the last year of experience, going backwards in time in the inner circles. The quantitative measure of the skill is represented as a colored region or area within the bounded area.

In addition, the system may automatically generate and present a report including advantages and disadvantages of a candidate with relation to a job opening. Advantages may include, for example:
Skills that match the of required years of experience.
Skills that have years of experience from recent years.
Skills with a continuous distribution of years of experience.
Skills with some years of experience within the scope tolerated by the recruiter.
Single skills with a skill grade above a threshold.
Single skills grade which is higher than other candidates for the same position.
A total skills grade above a threshold.
Total skills grade which is higher than other candidates for the same position.
Skills with knowledge test score above a threshold.
Skills with knowledge test score which is higher than other candidates for the same position.
Total skills score which is above a threshold.
Total skills score which is higher than other candidates for the same position.
Final score which is above a threshold.
Final score which is higher than other candidates for the same position.
Good feedback from recommenders.
Candidate residency within the desired geographical scope for the position.
Candidate with salary expectations within the position salary defined range.
Candidate with positive feedback from interviews made by the recruiters.

Disadvantages may include, for example:
Skills that do not match the total years of required experience.
Skills that have years of experience from long-past years.
Skills with sporadic years of experience.
Skills with some experience years outside the scope tolerated by the recruiter.
Single skills which has skill grade below a threshold.
Single skills grade which is lower than other candidates for the same position.
Total skills grade below a threshold.
Total skills grade which is lower than other candidates for the same position.
Skills with low knowledge test score.
Skills with knowledge test score which is lower than other candidates for the same position.
Total skills score which is below a threshold.
Total skills score which is lower than other candidates for the same position.
Final score which is below a threshold.
Final score which is lower than other candidates for the same position.
Poor feedback from recommenders.
Candidate residency outside the desired geographical scope for the position.
Candidate with salary expectations outside the position salary defined range.
Candidate with negative/neutral feedback from interviews made by the recruiters.
An automated detection and notification of overqualification of a candidate.

The modified radar charts and the reports (some or all) may be presented to the recruiter and to the candidate.

According to some embodiments of the invention, in operation 114, summarized interview page about the candidate may be generated for the recruiter. The summarized interview page may be generated prior to performing an interview. The summarized interview page may include relevant information gathered and generated for the candidates including modified radar graphs, candidate's advantages and disadvantages, knowledge test results as well as relevant technical questions the interviewer can ask the candidate during the interview to ensure his technical knowledge and abilities. Additionally, the interview page may include issues that need to be clarified in case of suspected mistakes, lack of information or suspicion of a fraud by the candidate. The summarized interview page may assist the recruited for preparing and conducting the interview.

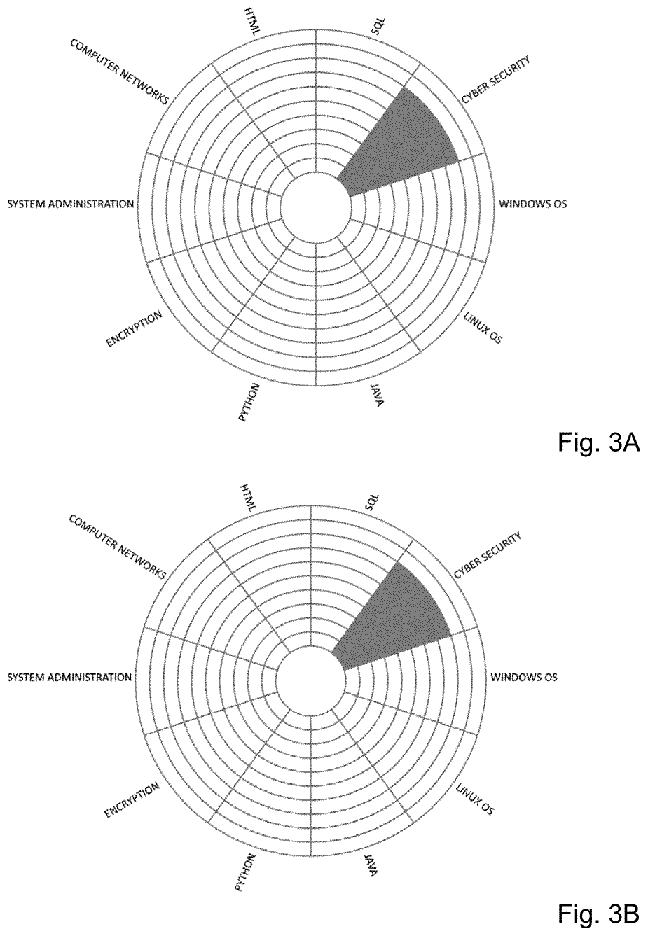

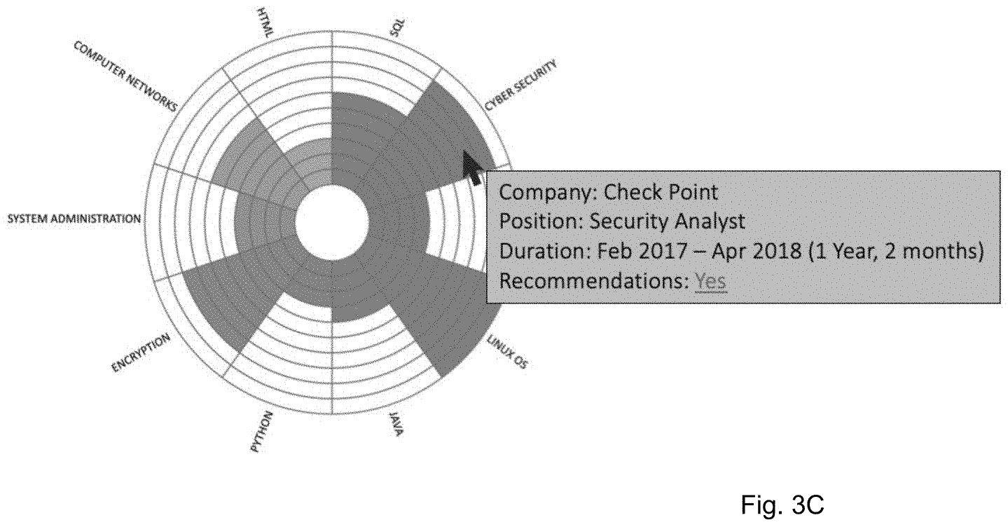

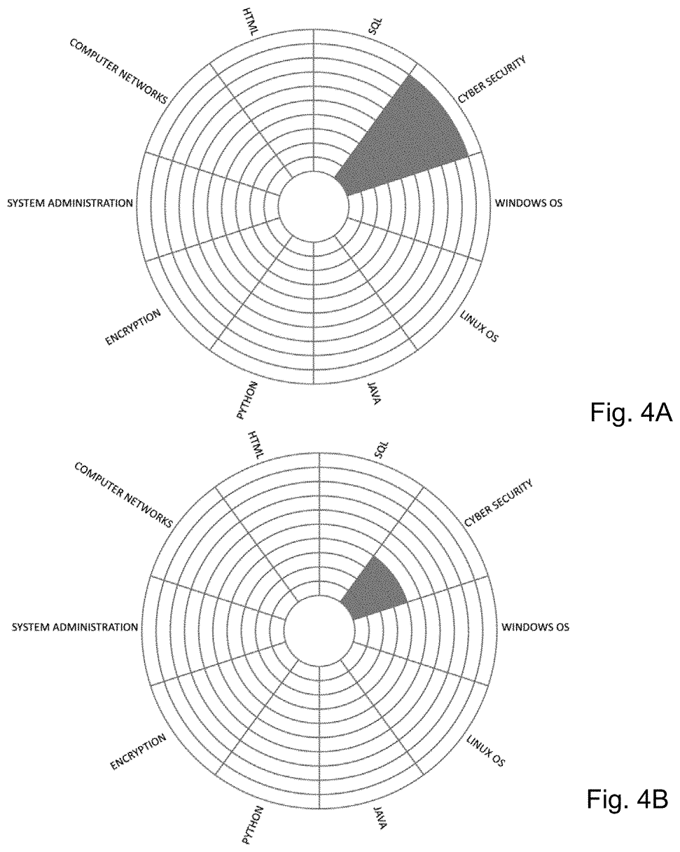

For example, each of FIGS. 3A and 4A depicts a modified radar chart for an open position, and each of FIGS. 3B and 4B depicts a modified radar chart of a candidate, according to some embodiments of the invention. FIG. 3C depicts a modified radar chart for a candidate including a popup window, according to some embodiments of the invention. As can be seen in FIG. 3A, eight years of experience in the field of cyber security are required for the open position, and as can be seen in FIG. 3B, the candidate has eight years of experience. In this example, the skill grade of the candidate may equal 1 or 100%. In the Example presented in FIG. 4A, nine years of experience in the field of cyber security are required for the open position, and as can be seen in FIG. 4B, the candidate has four years of experience. In this example, the skill grade of the candidate may equal 0.44 or 44%. In the Examples of FIGS. 3A-4B, no specific timeline is provided. In some embodiments, when a recruiter will mouse hover upon a certain year of experience, additional key importance pieces of information about that year may appear inside a pop-up window, as depicted in FIG. 3C.

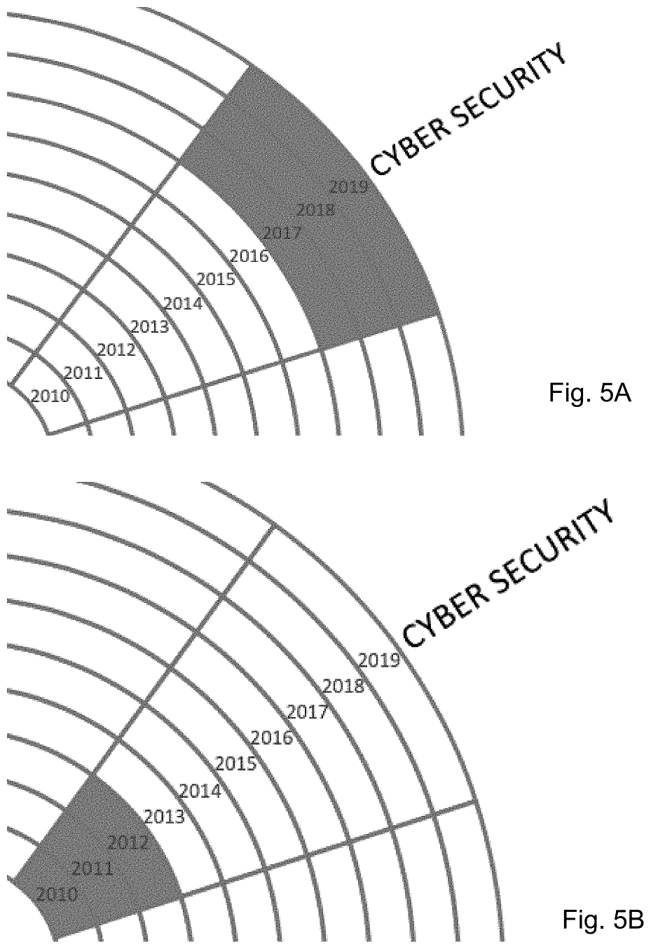

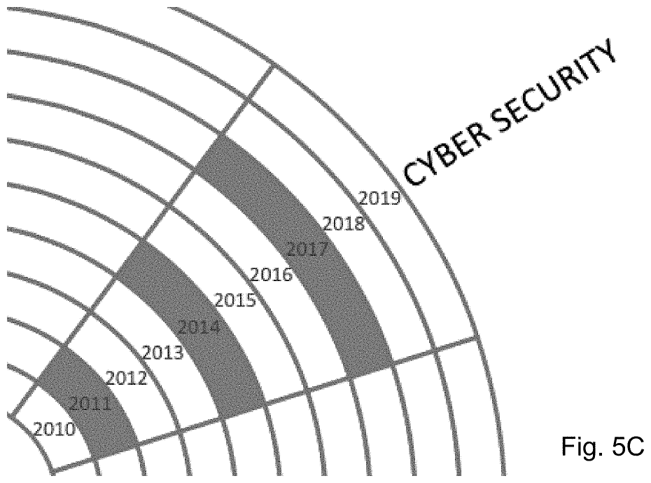

FIGS. 5A-5C depict examples for timeline of years of experience a candidate has in a skill or field of expertise, according to some embodiments of the invention. In each of these figures, the candidate has three years of experience in the field of cyber security. However, in FIG. 5A, the three years of experience are continuous and recent, while in FIG. 5B, the three years of experience are continuous but last from ten to seven years ago. In FIG. 5C, the three years of experience are not continuous. Thus, a recruiter may grasp the level of past experience of the candidate very easily, just by observing the modified radar chart.

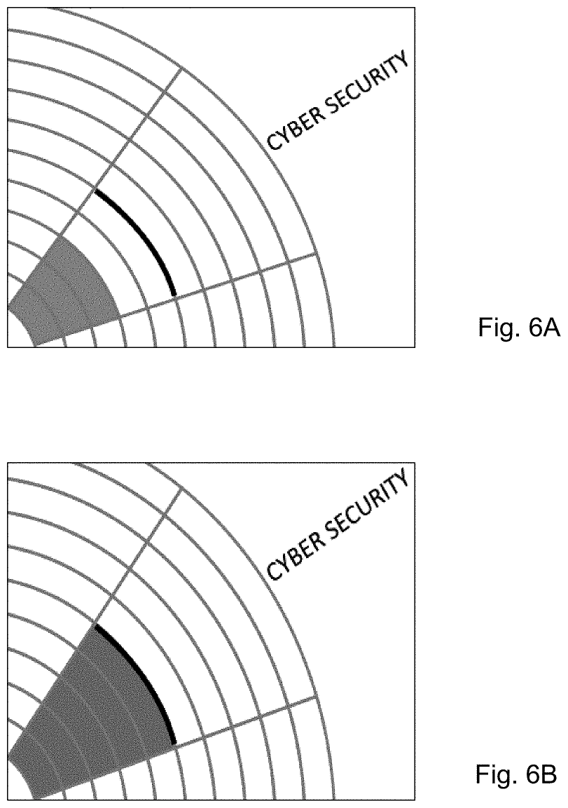

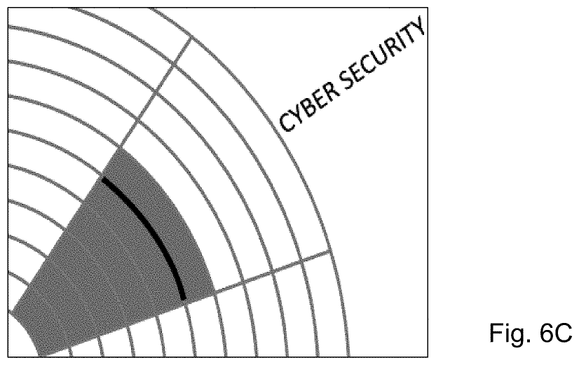

According to some embodiments, the modified radar chart may present the quantitative measures of the plurality of skills of the candidate and the required years of experience for the open position. For example, the quantitative measures, e.g., number of years of experience, of the plurality of skills of the candidate may be presented as colored bounded areas, and the required years of experience may be visualized as a think line. FIGS. 6A-6C depict partial modified radar graphs, with marking of required years of experience, according to some embodiments of the invention. In each of these partial modified radar graphs, five years of experience in cyber security are required. However, in FIG. 6A, the candidate has only three years of experience in cyber security, in FIG. 6B, the candidate has exactly five years of experience in cyber security, and in FIG. 6C, the candidate has more than five years of experience in cyber security. Thus, a recruiter may easily grasp the level of expertise of the candidate verses the required level of expertise required for the open position.

In some embodiments, the colored regions or areas may be color coded. For example, if the candidate does not have enough years of experience in a field of expertise, then the colored areas in the modified radar chart in this field of expertise may be provided in a first color, if the candidate has the exact required years of experience in a field of expertise, then the colored areas in the modified radar chart in this field of expertise may be provided in a second color, and if the candidate has more years of experience than required in a field of expertise, then the colored areas in the modified radar chart in this field of expertise may be provided in a third color. Other visual indications may be used.

According to some embodiments, the modified radar chart may present both the quantitative measures (e.g., number of years of experience) of the plurality of skills of the candidate and the results of the knowledge tests in the plurality of skills, for example using color coding. For example, the number of years of expertise may be marked in lighter hue or shade, and the results of the knowledge test may be marked in a dark hue or shade of the same color. Thus, if the results of the knowledge test match the expected knowledge level for a given number of years of experience, the colored area may be filled only with the dark hue. However, if the results of the knowledge test are below the expected knowledge level for a given number of years of experience, some of the colored area may be filled with the dark hue, representing the level of knowledge as manifested in the knowledge test, and some of the colored area may be filled with the lighter hue, representing the years of experience. Other visual indications may be used.

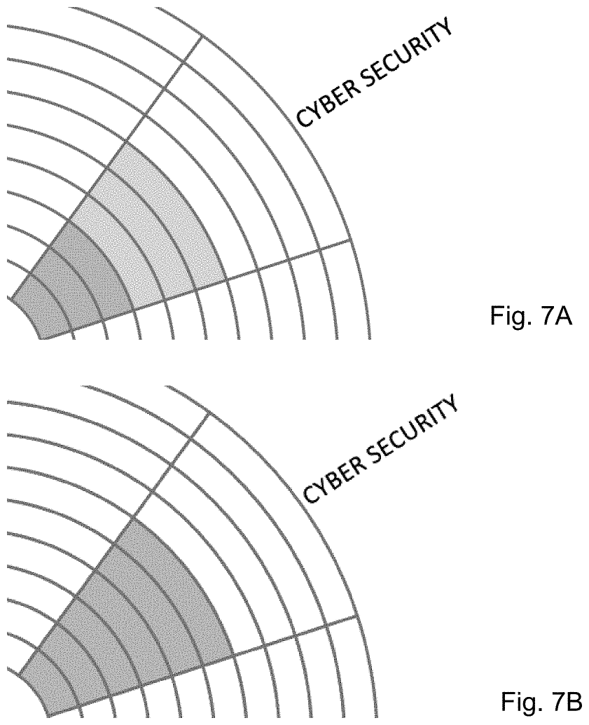

FIGS. 7A and 7B depict a modified radar graph including the number of years of experience together with the results of the knowledge test, according to some embodiments of the invention. In both FIGS. 7A and 7B, the candidate has six years of experience in the field of cyber security. However, In FIG. 7A, the results of his knowledge test are below the expected knowledge level for six of years of experience and match the expected knowledge level for about three of years of experience. Thus, an area of three years of experience is filled with darker shade or hue of grey, and an area of three years of experience is filled with lighter shade of grey. In FIG. 7B, the candidate has six years of experience in the field of cyber security, and the results of his knowledge test match the expected knowledge level for six of years of experience. Thus, the entire area of six years of experience is filled with the darker shade or hue of grey. Thus, the recruiter may easily grasp the level of agreement between the number of years of experience the candidate declares that he has in a certain field of expertise, and his actual knowledge level as manifested in the knowledge test.

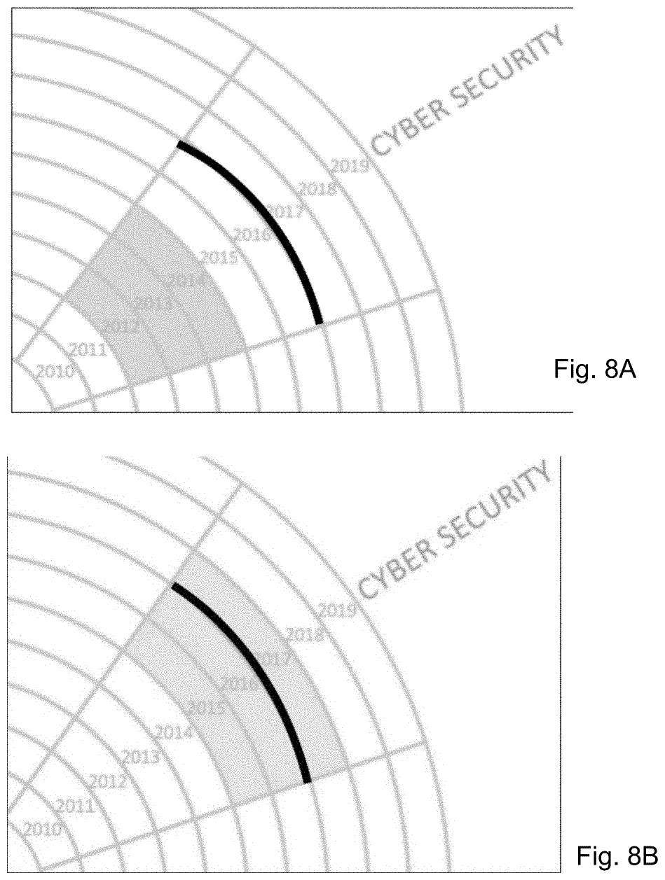

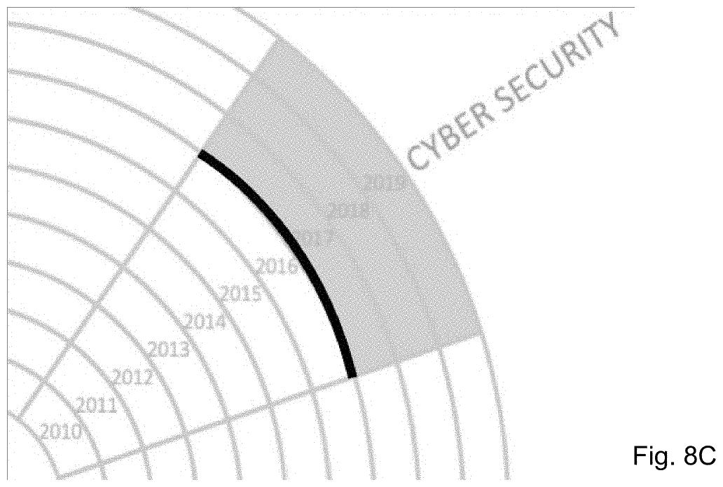

According to some embodiments, the modified radar chart may present a timeline of the years of experience the candidate has in a skill together with an indication of an allowed range of years of experience. For example, the timeline of the years of experience may be presented as colored regions or areas, and the indication of the allowed range of years of experience may be provided as a thick line representing the oldest year of experience allowed, as defined by the recruiter. FIGS. 8A-8C depict modified radar graphs including timeline of years of experience with a marking of the oldest allowed year of experience, according to some embodiments of the invention. For example, in FIGS. 8A-8C, the oldest allowed year of experience is 2017. In FIG. 8A, the candidate has three years of experience in cyber security, but these years are prior to the allowed range. In FIG. 8B, the candidate has three years of experience in cyber security, some before and some after the allowed range. In FIG. 8C, the candidate has three years of experience in cyber security, all within the allowed range. Again, the years of experience may be color coded to indicate if they are within or before the allowed range. Color coding may be used to indicate other measures, for example, continuity of years of experience.

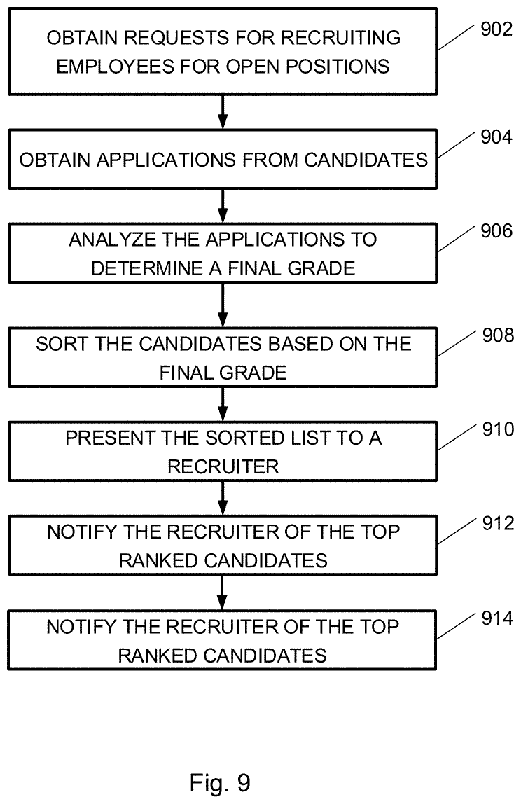

Reference is now made to FIG. 9, which is a flowchart of an automated method for recruiting a plurality of employees for a plurality of open positions, according to embodiments of the invention. The automated method for recruiting a plurality of employees for a plurality of open positions may be performed, for example, by processor 1205 presented in FIG. 12, or other system.

In operation 902, at least one request for recruiting at least one employee for at least one open position may be obtained. In operation 904, at least one job application from at least one candidate may be obtained. In operation 906, one or more job applications may be analyzed as disclosed herein to calculate a final grade to the one or more of the candidates, with relation to one or more open positions. As disclosed herein, the skill grades are calculated as the relation between the quantitative measure of the required skill and the quantitative measure of the skill of the candidate. Thus, skill grades of a single candidate may be different with relation to different job openings, since the measure of the required skills may be different. In operation 908, the candidates may be sorted based on the final grades. A different sorted list may be generated for each of the open positions. Other parameters may be taken into account such as single skill total years of experience, single skill years of experience distribution, single skill grade, total skills grade, single skill knowledge test score, cumulative knowledge test score, ranks provided by recommenders, salary expectations, feedback from company interviews, etc.

In operation 910, the sorted lists may be presented to the relevant recruiters (e.g., the recruiters that are involved with the recruiting process for the specific job opening). In operation 912, the relevant recruiters may be notified of the top ranked candidates, e.g., the candidates with the highest final grades. The recruiter may obtain a list of a predetermined number or percentage of candidate with the highest final grades. According to some embodiments, when clicking a certain candidate name on the list, a full candidate page may be opened, showing summarized information about the candidate and allowing additional automated interactions with the candidate. In operation 914, a notification suggesting scheduling an interview may be sent to the top ranked candidates. The notification may be sent automatically, e.g., upon approval of the recruiter.

According to some embodiments, if a candidate that applied for a first open position is found to be more suitable for other open position in the organization, e.g., if the final score of the candidate for the other position is higher than for the current position, then the recruiter may be notified about it.

According to some embodiments of the invention, after a certain amount of time since a position was recruited, the manager of the employee may rank the level of candidate suitability for the position. Thus, characteristics that are common to successful recruitments may be detected, and provided to recruiters. The characteristics may include, for example, grades the candidate obtained as well as other parameters. Similar parameters or characteristics shared between successful recruits may be detected, for example, using AI algorithms.

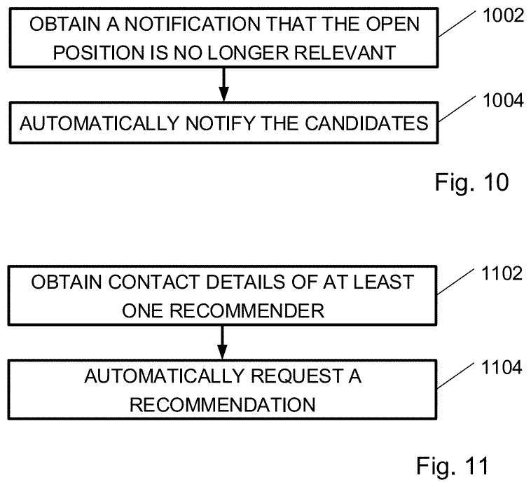

Reference is now made to FIG. 10, which is a flowchart of an automated method for closing job opening listings, according to some embodiments of the invention. The continuation of the method for automated employees' recruitment may be performed, for example, by processor 1205 presented in FIG. 12, or another system. In operation 1002, a notification that the open position is no longer relevant may be obtained, e.g., from a recruiter. For example, a notification that the open position is no longer relevant may be obtained if the open position has been staffed or is no longer required. In operation 1004, a notification may be sent automatically to the plurality of candidates that applied to the open position to inform them that the open position is no longer relevant. Similarly, if a notification that the recruiter has decided not to proceed with a certain candidate, an automated notification (e.g., an email message) may be sent to the candidate.

Reference is now made to FIG. 11, which is a flowchart of an automated method for requesting recommendations, according to some embodiments of the invention. The automated method for requesting recommendations may be performed, for example, by processor 1205 presented in FIG. 12, or another system. In operation 1102, contact details of at least one recommender may be obtained, e.g., from a candidate. For example, a candidate may provide contact details, e.g., e-mail addresses of a recommender as part of the job application. In operation 1104, a request for a recommendation may be sent to the at least one recommender using the contact details.

Reference is made to FIG. 12, showing a high-level block diagram of an exemplary computing device according to some embodiments of the present invention. Computing device 1200 may include a processor or controller 1205 that may be, for example, a central processing unit processor (CPU), a graphics processing unit (GPU), a chip or any suitable computing or computational device, an operating system 1215, a memory 1220, executable code 1225, storage or storage device 1230, input devices 1235 and output devices 1245. Controller 1205 may be configured to carry out methods described herein, and/or to execute or act as the various modules, units, etc., for example by executing code or software. More than one computing device 1200 may be included. Micro-services, engines, processes, and other modules described herein may be for example software executed (e.g., as programs, applications or instantiated processes, or in another manner) by one or more controllers 1205. Multiple processes discussed herein may be executed on the same controller.

Operating system 1215 may be or may include any code segment (e.g., one similar to executable code 1225 described herein) designed and/or configured to perform tasks involving coordination, scheduling, arbitration, supervising, controlling or otherwise managing operation of computing device 1200, for example, scheduling execution of software programs or enabling software programs or other modules or units to communicate. Operating system 1215 may be a commercial operating system.

Memory 1220 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 1220 may be or may include a plurality of, possibly different memory units. Memory 1220 may be a computer or processor non-transitory readable medium, or a computer non-transitory storage medium, e.g., a RAM.

Executable code 1225 may be any executable code, e.g., an application, a program, a process, task or script. Executable code 1225 may be executed by controller 1205 possibly under control of operating system 1215. For example, executable code 1225 may be an application that when executed performs automated employees recruitment as further described herein. Although, for the sake of clarity, a single item of executable code 1225 is shown in FIG. 12, a system according to some embodiments of the invention may include a plurality of executable code segments similar to executable code 1225 that may be loaded into memory 1220 and cause controller 1205 to carry out methods described herein. For example, units or modules described herein may be, or may include, controller 1205 and executable code 1225.

Storage device 1230 may be any applicable storage system, e.g., a disk or a virtual disk used by a VM. Storage 1230 may be or may include, for example, a hard disk drive, a floppy disk drive, a Compact Disk (CD) drive, a CD-Recordable (CD-R) drive, a Blu-ray disk (BD), a universal serial bus (USB) device or other suitable removable and/or fixed storage unit. Content or data may be stored in storage 1230 and may be loaded from storage 1230 into memory 1220 where it may be processed by controller 1205. In some embodiments, some of the components shown in FIG. 12 may be omitted. For example, memory 1220 may be a non-volatile memory having the storage capacity of storage 1230. Accordingly, although shown as a separate components, storage 1230 may be embedded or included in memory 9120.

Input devices 1235 may be or may include microphones, a mouse, a keyboard, a touch screen or pad or any suitable input device. It will be recognized that any suitable number of input devices may be operatively connected to computing device 1200 as shown by block 1235. Output devices 1245 may include one or more displays or monitors, speakers and/or any other suitable output devices. It will be recognized that any suitable number of output devices may be operatively connected to computing device 1200 as shown by block 1245. Any applicable input/output (I/O) devices may be connected to computing device 1200 as shown by input devices 1235 and output devices 1245. For example, a wired or wireless network interface card (NIC), a printer, a universal serial bus (USB) device or external hard drive may be included in input devices 1235 and/or output devices 1245.

Some embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, an article may include a storage medium such as memory 1220, computer-executable instructions such as executable code 1225 and a controller such as controller 1205.

The storage medium may include, but is not limited to, any type of disk including, semiconductor devices such as read-only memories (ROMs) and/or random access memories (RAMs), flash memories, electrically erasable programmable read-only memories (EEPROMs) or any type of media suitable for storing electronic instructions, including programmable storage devices. For example, in some embodiments, memory 1220 is a non-transitory machine-readable medium.

A system according to some embodiments of the invention may include components such as, but not limited to, a plurality of central processing units (CPU) or any other suitable multi-purpose or specific processors or controllers (e.g., controllers similar to controller 905), a plurality of input units, a plurality of output units, a plurality of memory units, and a plurality of storage units. A system according to some embodiments of the invention may additionally include other suitable hardware components and/or software components. In some embodiments, a system may include or may be, for example, a personal computer, a desktop computer, a laptop computer, a workstation, a server computer, a network device, or any other suitable computing device. For example, a system according to some embodiments of the invention as described herein may include one or more devices such as computing device 1200.

Different embodiments are disclosed herein. Features of certain embodiments may be combined with features of other embodiments; thus certain embodiments may be combinations of features of multiple embodiments.

Some embodiments of the invention may include an article such as a computer or processor readable non-transitory storage medium, such as for example a memory, a disk drive, or a USB flash memory device encoding, including or storing instructions, e.g., computer-executable instructions, which when executed by a processor or controller, cause the processor or controller to carry out methods disclosed herein.

While the invention has been described with respect to a limited number of embodiments, these should not be construed as limitations on the scope of the invention, but rather as exemplifications of some of the preferred embodiments. Other possible variations, modifications, and applications are also within the scope of the invention. Different embodiments are disclosed herein. Features of certain embodiments may be combined with features of other embodiments; thus certain embodiments may be combinations of features of multiple embodiments.

1. A computer implemented method for automated employees' recruitment comprising:
obtaining from a recruiter a request for recruiting an employee for an open position, wherein the request comprises quantitative measures of a plurality of required skills;
obtaining an application from a candidate, the application comprising quantitative measures of a plurality of skills of the candidate;
analyzing the application to determine a level of suitability of the candidate for the open position based on the quantitative measures of a plurality of required skills and the quantitative measures of a plurality of skills of the candidate; and
presenting the level of suitability to the recruiter.

2. The method of claim 1, wherein analyzing the application to determine a level of suitability of the candidate for the open position comprises:
calculating relative grades for at least one of the plurality of required skills, wherein a relative grade of a required skill is calculated based on a relation between the quantitative measure of the required skill and the quantitative measure of the skill of the candidate;
calculating a total skills grade based on the relative grades of the required skills;
generating a knowledge test related to at least one of the required skills;
presenting the knowledge test to the candidate and obtaining knowledge test results;
calculating a knowledge test grade based on the knowledge test results; and
calculating a final grade for the candidate based on the total skills grade and the knowledge test grade, the final grade suggesting the level of suitability of the candidate for the new position.

3. The method of claim 1, wherein the quantitative measure of the required skill is the number of required years of experience in the required skill and the quantitative measure of the skill of the candidate is the years of experience the candidate has in the required skill.

4. The method of claim 3, wherein the quantitative measure of the skill of the candidate is adjusted according to the timeline of the years of experience the candidate has in the required skill.

5. The method of claim 1, comprising:
obtaining a plurality of applications from a plurality of candidates and analyzing each of the plurality of applications to obtain a final grade for each of the candidates;
sorting the candidates based on the final grades; and
presenting the sorted list to a recruiter.

6. The method of claim 5, comprising:
automatically sending a notification to the top ranked candidates to schedule an interview with the top ranked candidates.

7. The method of claim 5, comprising:
obtaining from a recruiter a notification that the open position is no longer relevant; and
automatically notifying the plurality of candidates that the open position is no longer relevant.

8. The method of claim 1, comprising:
obtaining contact details of at least one recommender; and
automatically sending a request for a recommendation to the at least one recommender using the contact details.

9. The method of claim 1, comprising:
obtaining a plurality of requests for recruiting employees for a plurality of open positions;
upon obtaining the application from the candidate for the open position, analyzing the application to determine a level of suitability of the candidate at least one other open position of the plurality of open positions; and
notifying the recruiter if the level of suitability of the candidate with relation to any of the at least one other open position is above a threshold.

10. The method of claim 1, comprising:
presenting the quantitative measures of a plurality of skills of the candidate to the recruiter in a modified radar chart in which an area bounded by two adjacent radii represents a skill of the candidate and the quantitative measure of the skill is represented as a colored region within the bounded area.

11. A system for automated employees recruitment, the system comprising:
a memory;
a processor configured to:
obtain from a recruiter a request for recruiting an employee for an open position, wherein the request comprises quantitative measures of a plurality of required skills;
obtain an application from a candidate, the application comprising quantitative measures of a plurality of skills of the candidate;
analyze the application to determine a level of suitability of the candidate for the open position based on the quantitative measures of a plurality of required skills and the quantitative measures of a plurality of skills of the candidate; and
present the level of suitability to the recruiter.

12. The system of claim 11, wherein analyzing the application to determine a level of suitability of the candidate for the open position comprises:
calculating relative grades for at least one of the plurality of required skills, wherein a relative grade of a required skill is calculated based on a relation between the quantitative measure of the required skill and the quantitative measure of the skill of the candidate;
calculating a total skills grade based on the relative grades of the required skills;
generating a knowledge test related to at least one of the required skills;
presenting the knowledge test to the candidate and obtaining knowledge test results;
calculating a knowledge test grade based on the knowledge test results; and
calculating a final grade for the candidate based on the total skills grade and the knowledge test grade, the final grade suggesting the level of suitability of the candidate for the new position.

13. The system of claim 11, wherein the quantitative measure of the required skill is the number of required years of experience in the required skill and the quantitative measure of the skill of the candidate is the years of experience the candidate has in the required skill.

14. The system of claim 13, wherein the quantitative measure of the skill of the candidate is adjusted according to the timeline of the years of experience the candidate has in the required skill.

15. The system of claim 11, wherein the processor is configured to:
obtain a plurality of applications from a plurality of candidates and analyze each of the plurality of applications to obtain a final grade for each of the candidates;
sort the candidates based on the final grades; and
present the sorted list to a recruiter.

16. The system of claim 15, wherein the processor is configured to:
automatically send a notification to the top ranked candidates to schedule an interview with the top ranked candidates.

17. The system of claim 15, wherein the processor is configured to:
obtain from a recruiter a notification that the open position is no longer relevant; and
automatically notify the plurality of candidates that the open position is no longer relevant.

18. The system of claim 11, wherein the processor is configured to:
obtain contact details of at least one recommender; and
automatically send a request for a recommendation to the at least one recommender using the contact details.

19. The system of claim 11, wherein the processor is configured to:
obtain a plurality of requests for recruiting employees for a plurality of open positions;
upon obtaining the application from the candidate for the open position, analyze the application to determine a level of suitability of the candidate at least one other open position of the plurality of open positions; and
notify the recruiter if the level of suitability of the candidate with relation to any of the at least one other open position is above a threshold.

20. The system of claim 11, wherein the processor is configured to:
present the quantitative measures of a plurality of skills of the candidate to the recruiter in a modified radar chart in which an area bounded by two adjacent radii represents a skill of the candidate and the quantitative measure of the skill is represented as a colored region within the bounded area.
